(19) United States
(12) Patent Application Publication
(10) Pub. No.: US 2016/0224584 A1
(43) Pub. Date: Aug. 4, 2016

(54) System and Method for Reciprocal Deletion of Historical Records

(71) Applicant: Raketu Communications, Inc., New York, NY (US)

(72) Inventor: Gregory T. Parker, New York, NY (US)

(21) Appl. No.: 15/011,715

(22) Filed: Feb. 1, 2016

Related U.S. Application Data
(60) Provisional application No. 62/110,939, filed on Feb. 2, 2015.

(51) Int. Cl. G06F 17/30

(52) U.S. Cl. CPC G06F 17/30117; G06F 17/30424

(57) ABSTRACT

A system and method for reciprocal deletion of historical records is disclosed. Conventional electronic record keeping systems in OTT (Over-The-Top) content services either do not allow deletion of entire or selective records, or allow deletion of entire or selective records locally on the device. Unlike conventional systems and methods, the invention allows one device to remove entire historical records, or a select set of one or more of the entries, from the device and from the corresponding devices that also contains the historical records. In this way, the OTT historical record is removed from the originating device and the recipient device. In addition, the system can be configured to remove the corresponding historical records if they exists in an archive (ex. cloud server). The invention allows for the reciprocal deletion of OTT historical records on multiple devices.

Priority is claimed from U.S. provisional patent application Ser. No. 62/110,939, filed Feb. 2, 2015.

### FIELD OF INVENTION

The present invention relates generally to text, voice and video records, communications, and messages generated in Over-The-Top (OTT) systems, and more particularly to a system and method for the local and remote deletion of OTT historical records of sending and receiving digital information on mobile devices.

### BACKGROUND

Mobile and desktop devices connecting to an Internet Protocol (IP) network typically carry out many forms of communications activities. More specifically, Over-The-Top (OTT) messaging, audio and video communications. Unlike traditional Short Message Service (SMS) Text for text messaging, which uses a proprietary format across a proprietary control channel, OTT messaging occurs over standard IP communications channels typically over TCP/IP and does not require a telecommunications operator or carrier to facilitate the exchange, but rather may rely upon an internet service provider to pass along information packets.

Current systems track OTT transactions either with textual records of these transactions having occurred or with the content itself. In addition to these local records on the sender and recipient devices, the provisioning provider may also have duplicate historical records in an archive stored in the cloud for example. In some cases, no deletion of records on the device is permitted. In other cases, deletion of the entire historical record on the device is permitted. In other cases, deletion of selective historical records on the device is permitted. In all of these cases, the permitted deletion occurs only on the single device. The historical records persist on the recipient devices, and in the case where the provisioning provider has a duplicate of the records, they also persist in the provider′ archive or storage.

By not deleting all occurrences of the historical record, the device, and the user of the device, may falsely believe that they have deleted records that have in fact not been deleted and may be reproduced at some later time. In the conventional system, FIG. 1, the device (A) initiates the deletion locally (101) on the device (A), which deletes the local copy of the historical record to be deleted from the local storage (A1). Any copies of the historical record (B1) or (C1) which may be located on a remote device (B) or intermediate provider archive (C) still exist.

The invention facilitates the device to delete all of the historical records selected by the user locally, to delete the corresponding historical records on the corresponding recipient devices, and to delete the historical records from the provisioning provider where the provider has a duplicate of the records (archive). This ensures that when the device, or user of the device, deletes historical records, they are in fact deleted in their entirety.

Although the conventional systems of FIG. 1 allows for the deletion of local copies of the historical record(s), they do not provide for the deletion of the corresponding record(s) from the corresponding devices and from the provider archive (if one exists).

### SUMMARY OF THE INVENTION

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

The present invention, shown in FIG. 2, FIG. 3, FIG. 4, FIG. 5, and FIG. 6, relates generally to text, group chat, voice and video records, voice and video conferencing records, communications records, and messages generated in Over-The-Top (OTT) systems, and more particularly to a system and method for the local and remote deletion of OTT historical records of sending and receiving digital information on mobile and desktop devices.

The present invention provides a messaging and signaling system that results in providing the deletion of historical record(s) from a device, and from the device(s) that has the corresponding historical record(s) and from the provisioning providers archive (if the records also exist there). By deleting all occurrences of the historical record, the device, and the user of the device, have in fact removed the historical record.

In particular, the invention provides for a deletion instruction, sent from an originating device, to be processed by a receiving device, where the receiving device locates and deletes the identified historical record and then sends a confirmation message back to the originating device.

To the accomplishment of the foregoing and related ends, certain illustrative aspects of the invention are described herein in connection with the description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

FIG. 1 is a block diagram illustrating a prior art Conventional Deletion of Historical Record.

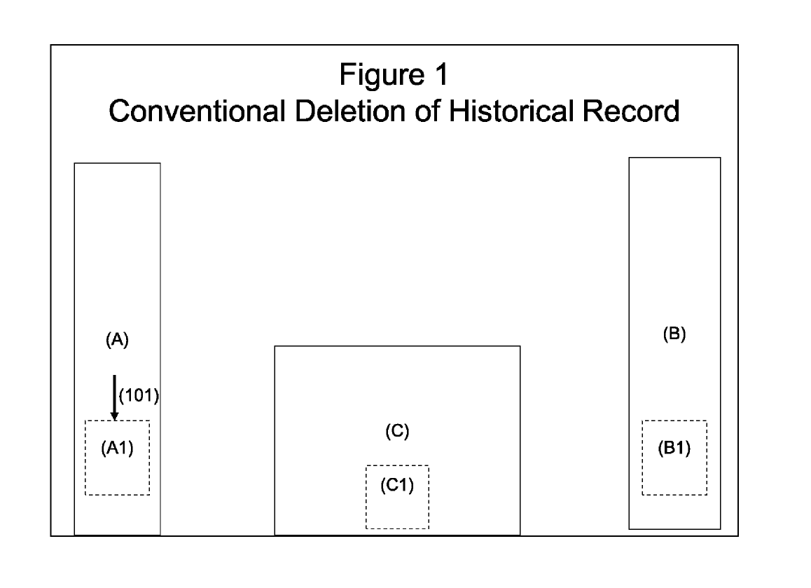

FIG. 2 is a block diagram illustrating a Reciprocal Deletion of Historical Record with no central archive—an aspect of the present invention.

FIG. 3 is a block diagram illustrating a Reciprocal Deletion of Historical Record with a central archive—an aspect of the present invention.

FIG. 4 is a block diagram illustrating a Reciprocal Deletion of Historical Record with no central archive and multiple recipients—an aspect of the present invention.

FIG. 5 is a block diagram illustrating a Reciprocal Deletion of Historical Record with central archive and multiple recipients—an aspect of the present invention.

FIG. 6 is a flow diagram illustrating a Reciprocal Deletion of Historical Record local deletion—an aspect of the present invention.

### DETAILED DESCRIPTION OF THE PREFERRED EMBODIMENT

The present invention facilitates the ability to deliver and coordinate the complete deletion of historical records within an Over-The-Top (OTT) system. The present invention facilities this ability with or without a central archive server in the system, and can be configured accordingly.

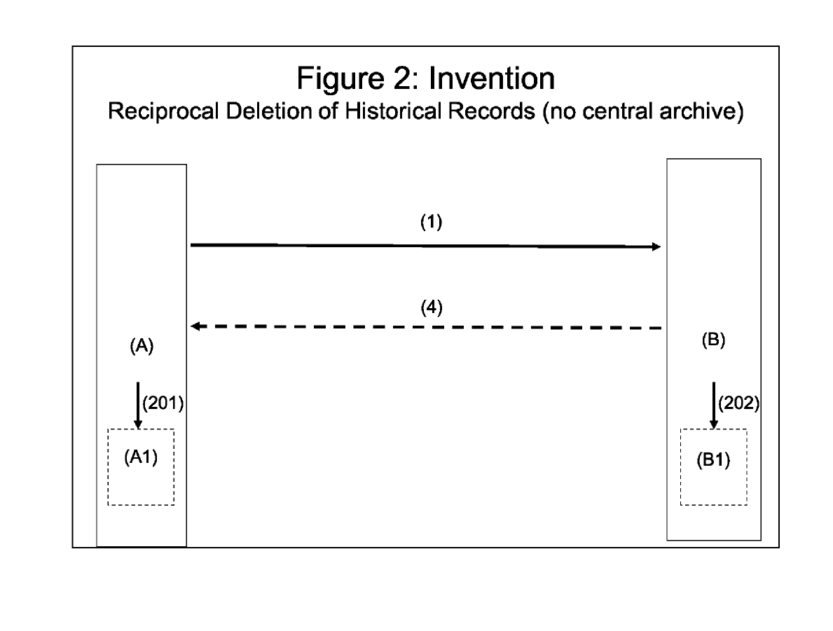

In FIG. 2, the mobile device (A) deletes an historical record of an OTT text conversation or an OTT video call record (for example) between device (A) and device (B). Once the device (A) acknowledges the local deletion (201) from the local storage (A1), a message is sent to device (B) directly (1) whereby device (B) upon appropriate authentication of the request, deletes the corresponding historical record locally (202) from local storage (B1). Depending on the configuration in the system, device (B) can respond to device (A) with a deletion outcome message (4) (example, success or failure), informing device (A) of the results of the request.

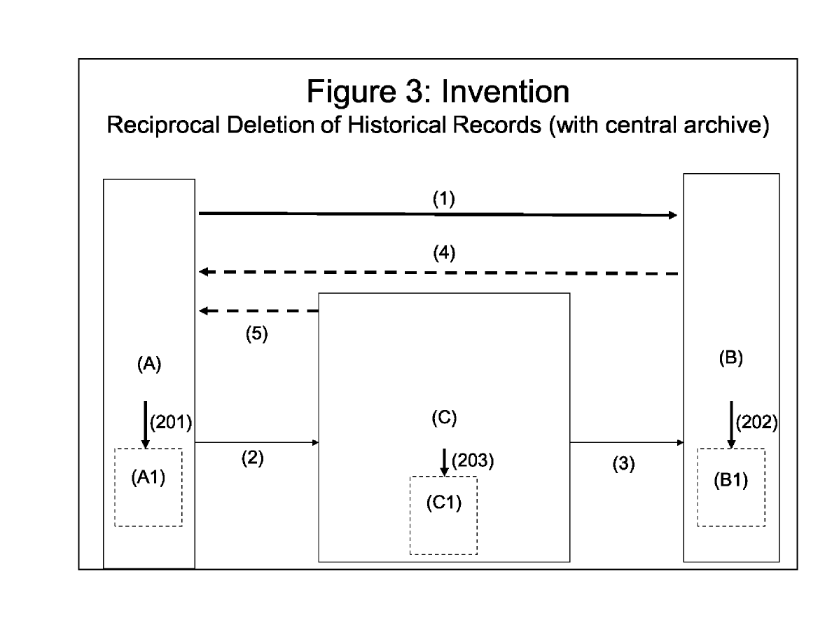

In FIG. 3, the mobile device (A) deletes an historical record of an OTT text conversation or an OTT video call record (for example) between device (A) and device (B). Once the device (A) acknowledges the local deletion (201) from the local storage (A1), a message (2) is sent to device (B) either directly (1) and/or via a relay (3) through device (C), whereby device (B) upon appropriate authentication of the request, deletes the corresponding historical record locally (202) from local storage (B1). Device (C) (example, a cloud server used for archive copies), upon receiving the message (2) from device (A), and upon appropriate authentication of the request, deletes the corresponding historical record locally (203) from local storage (C1). Depending on the configuration in the system, device (B) and/or device (C) can respond to device (A) with deletion outcome messages (4) and (5) (example, success or failure), informing device (A) of the results of the request. In this example, devices (B) and (C) act in the same manner to the deletion message from (A) with regard to the corresponding historical records stored therein.

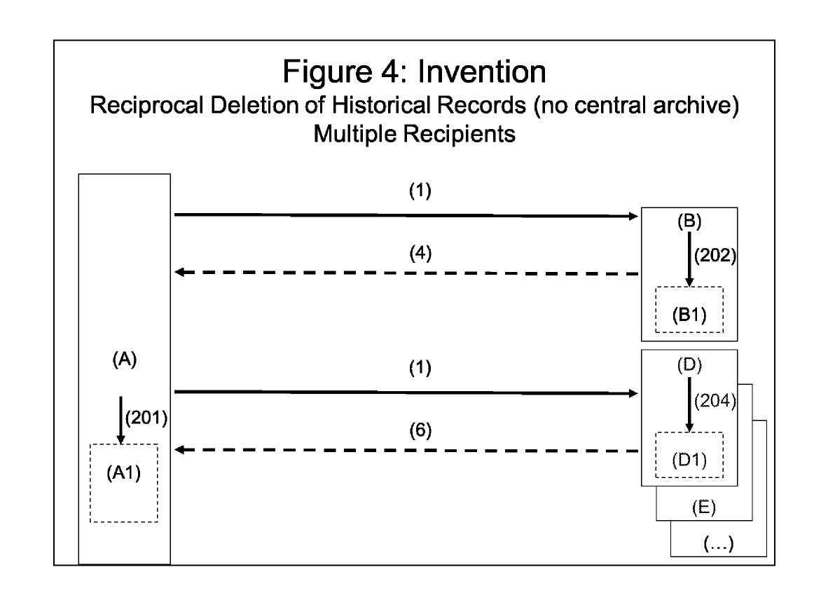

In FIG. 4, the mobile device (A) deletes an historical record of an OTT text conversation (for example group chat) or an OTT video conference call record (for example) between device (A) and multiple devices (B, D, E, . . . ). Once the device (A) acknowledges the local deletion (201) from the local storage (A1), a message is sent to the appropriate devices (B, D, E, . . . ) directly (1) whereby the receiving devices (B, D, E, . . . ) upon appropriate authentication of the request, delete the corresponding historical record locally (202, 204, . . . ) from local storage (B1, D1, . . . ). Depending on the configuration in the system, the recipient devices (B, D, . . . ) can respond to device (A) with a deletion outcome message (4, 6, . . . ) (example, success or failure), informing device (A) of the results of the request. In this example, each device (B, D, E, . . . ) act in the same manner to the deletion message from (A) with regard to the corresponding historical records stored therein.

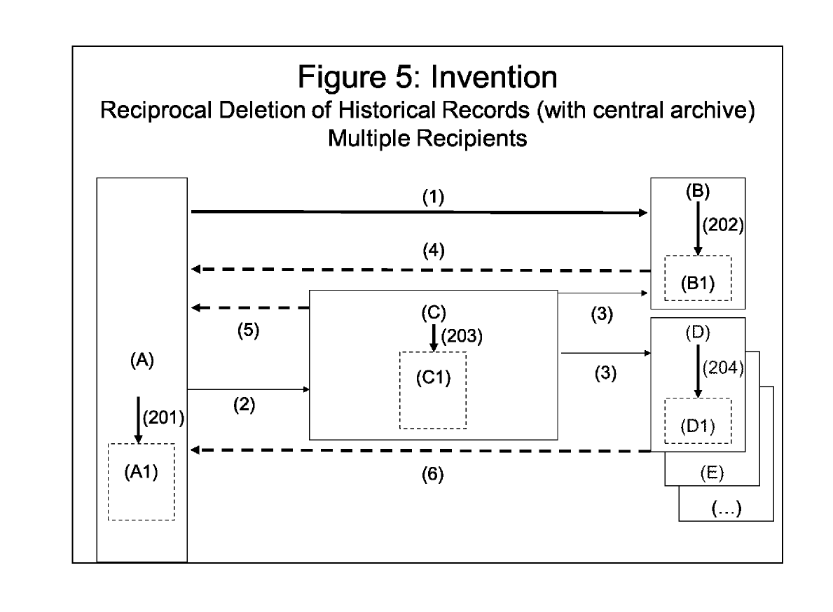

In FIG. 5, the mobile device (A) deletes an historical record of an OTT text conversation (for example group chat) or an OTT video conference call record (for example) between device (A) and multiple devices (B, D, E, . . . ). Once the device (A) acknowledges the local deletion (201) from the local storage (A1), a message is sent to the appropriate devices (B, D, E, . . . ) either directly (1) and/or via a relay, device (C), (2, 3), whereby the receiving devices (B, D, E, . . . ) upon appropriate authentication of the request, delete the corresponding historical record locally (202, 204, . . . ) from local storage (B1, D1, . . . ). Device (C) (example, a cloud server used for archive copies), upon receiving the message (2) from device (A), and upon appropriate authentication of the request, deletes the corresponding historical record locally (203) from local storage (C1). Depending on the configuration in the system, the recipient devices (B, D, . . . ) and/or device (C) can respond to device (A) with a deletion outcome message (4, 5, 6, . . . ) (example, success or failure), informing device (A) of the results of the request.

Should one or more of the recipient devices (B, D, E, . . . ) be off-network when the initial deletion request is sent to the devices (B, D, E, . . . ), it is queued on both device (A) and device (C) (if the system uses a central archive (C)) until such time as the devices (B, D, E, . . . ) become online at which time the deletion request is forwarded to the devices that were offline (B and/or D and/or E and/or . . . ) from device (A) and/or device (C) (if the system uses a central archive). Should device (A) be off-network when the initial deletion occurs, the device (A) is presented with choices to continue (for example, deletion not allowed until the device is online, the deletion has occurred on this device and will be relayed to the other device(s) when this device is back online, etc.) and the appropriate action is taken based on the response chosen.

Deletion of a single historical record (example, one text message or one voice call record) or multiple specific historical records are processed using the same methodology, a matching algorithm is used to match device (A)'s deleted historical records to the recipient device(s), as appropriate (B and/or D and/or . . . )'s historical records, and to device (C)'s historical records if required.

Deletion can originate from any of the devices participating in the communications “thread”. For example, device (B) could have originally initiated a voice call to device (A), whereby both device (B) and device (A) have the historical record of the voice call, and the deletion of the specific historical record could be originated by device (A) or device (B), resulting in the reciprocal deletion of the record off both devices (A, B) and off an archive device (C) if applicable, as described previous in the invention.

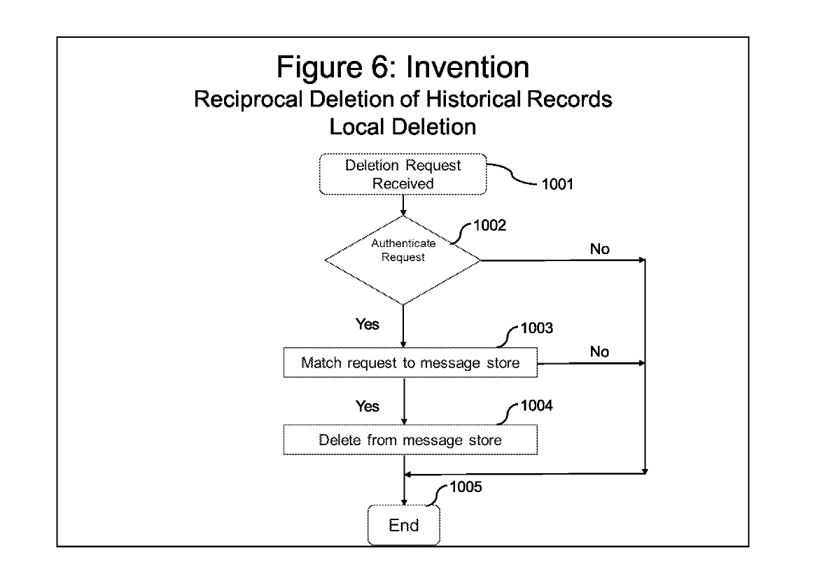

In FIG. 6, the deletion on each device is processed on each device based on the operating system database or file storage systems. Device (A) sends device (B) a deletion request. The incoming deletion message (1001) is received by device (B) and authenticated (1002) by device (B). The historical record(s) to be deleted are identified through matching (1003). The matching (1003) takes the incoming deletion request and matches it to a local copy of the original record by the user, the content and optionally timestamp and unique identifier on the record. Device (B) accesses its local storage (B1), either a database or file. If the local storage is a database file, for example, device (B) issues a query to the local database to delete (1004) the matching record (202). If the local storage is a file, device (B) reads the file analyzing the contents looking for a match based on the criteria above. Once the match is identified (1003), device (B) updates the content in memory and writes the content back to the local disk (202) as a file or local store (1004). If the content is encrypted, it must be decrypted prior to matching, and encrypted prior to saving locally. In either example, once the requested record is identified on the local device, it is removed from the local storage record (201, 202, 203, 204, . . . ), and optionally device (B) can be configured to respond with the outcome (4).

It should be noted that in the invention, if the provisioning provider does not store archival historical records, there is no requirement, for example, of device (A) sending a deletion message via device (C) or to device (C). Device (A) in this scenario directly sends the message from device (A) to device (B) (and multiple devices as appropriate), who authenticates the request and takes the appropriate action. It is only when the provisioning provider stores archival historical records that the deletion initiating device, (A), sends the deletion message to device (B) (and multiple devices as appropriate) and additionally to device (C) to delete its corresponding archival record(s) from (C1).

In order to secure the deletion message transactions, the messages (1, 2, 3) and any response messages (if the system is configured to send response messages) (4, 5, 6, . . . ) can be encrypted and decrypted by the respective devices.

From the description above, the embodiments of the invention show several advantages over prior art methods. The originator or source of a historical record has control not only over their historical records, but they can delete them from their device and direct the deletion from all other devices where corresponding records are stored. The recipient of a historical record has control over their own historical records, and can delete them from their device and direct the deletion from all other devices where corresponding records are stored. The user originating the deletion of a historical has confirmation that the record has been deleted. The originator and/or recipient can limit third party exposure to historical records by controlled deletion.

While certain novel features of the present invention have been shown and described, it will be understood that various omissions, substitutions and changes in the forms and details of the device illustrated and in its operation can be made by those skilled in the art without departing from the spirit of the invention.

I claim:

1. A method of deleting a data record on a first device comprising:
the first device receiving a message from a remote device, the message containing information identifying a record and instructions to delete the record;
searching through a database of data records to match the data record identified by the message;
deleting the identified data record; and
sending a confirmation message back to the remote device.

2. The method of claim 1, where the first device is a telecommunications device.

3. The method of claim 1, where the first device is a computer.

4. The method of claim 1, where the data record is an over the top message.

5. A method for the reciprocal deletion of a data record on multiple devices, the method comprising:
identifying a first data record on a first device;
deleting the first data record from the first device;
generating a deletion instruction on the first device;
transmitting the deletion instruction to a second device;
on the second device, matching the deletion instruction with a second data record;
on the second device, deleting the second data record and generating a confirmation message; and
transmitting the confirmation message to the first device.

6. A method for the deletion of a data record on a device, the method comprising:
selection of the data record within a database of data records;
obtaining identification information of the selected data record;
deletion of the selected data record;
transmitting the identification information of the selected data record to a remote device with instructions to delete the selected data record from the remote device; and
receiving confirmation from the remote device of the deletion of the selected data record.
